(19) United States
(12) Patent Application Publication
(10) Pub. No.: US 2012/0057663 A1
(43) Pub. Date: Mar. 8, 2012

(54) Terminal State Management in a Telecommunications Network

(75) Inventor: Mickael Bouyaud, Le Mans (FR)

(73) Assignee: ST-ERICSSON SA, Plan-les-Ouates (CH)

(21) Appl. No.: 13/266,185

(22) PCT Filed: Apr. 30, 2010
(86) PCT No.: PCT/EP2010/055928

§ 371 Date: Oct. 25, 2011

(30) Foreign Application Priority Data
Apr. 30, 2009 (FR) 09 52917

(51) Int. Cl. H04L 27/06

(52) U.S. Cl. 375/343

(57) ABSTRACT

A signal transmitted in a radio telecommunications network is received (41). This radio signal carries a common pilot channel and another channel, with said other channel carrying state information. Then one obtains (42), from the radio signal, a first signal by channel estimation on the common pilot channel and a second signal by correlation of the received radio signal with a reference code. Next, a resulting signal is obtained (43) by complex conjugate multiplication of the first signal with the second signal. Lastly, a value for the state information indicated in the second signal is determined (44) on the basis of the resulting signal.

This invention relates to radio telecommunications networks, and more specifically to managing the active or standby state of a terminal in such a network.

A UMTS (Universal Mobile Telecommunications System) telecommunications network comprises multiple radio cells which are managed by base stations. Each base station manages the communications of terminals located in the cell or cells for which it is responsible. FIG. 1 illustrates such a radio telecommunications network comprising base stations 11 which manage cells 12 containing terminals 13.

A mobile terminal can be in an active state, in particular when it is involved in a communication, or it can be in a standby state when it is not receiving or exchanging information with the network. One should note that the standby state of a terminal advantageously allows it to limit its power consumption. To preserve the power autonomy of these terminals, a terminal which is not actively communicating is kept in a standby state, and is awakened when it needs to be active, for example when it has an incoming message or communication.

For this purpose, the state the terminal should be in is regularly indicated to it. A physical channel referred to as PICH in the context of a UMTS network (for Paging Indicator Channel) is adapted to carry this state information, known as the Paging Indicator or PI.

Thus, a terminal which is in the standby state is periodically activated in order to read the Paging Indicator carried by the PICH channel.

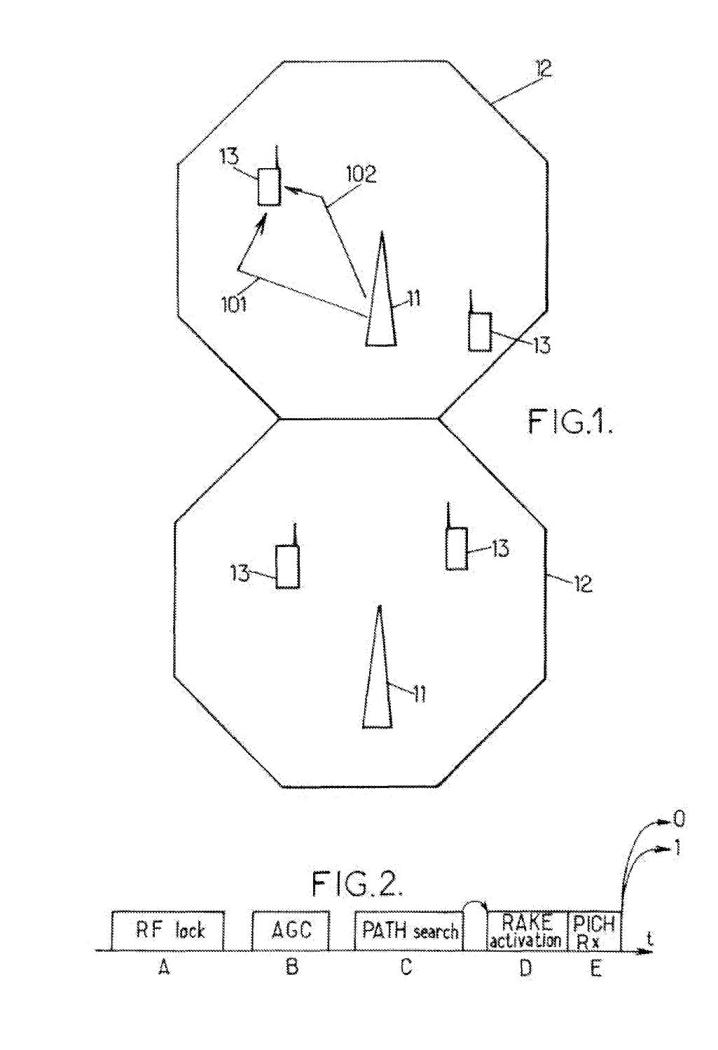

FIG. 2 illustrates a sequence of steps implemented in such a terminal which is in standby mode and which periodically wakes to determine whether the signal carried by the PICH channel is indicating that it should switch to active mode according to an embodiment of the invention.

In a step A, the terminal activates its radio parameters to be ready to receive (called the RF lock phase). In a step B, the terminal carries out an automatic gain control (AGC) step. Then in a step C, the terminal applies a path detection algorithm, also known as a matched filtering algorithm or path search.

This step C allows determining the time lags between different radio paths between the base station and terminal. A signal sent between the base station and a terminal can travel several different paths, such as a path 101 and a path 102 for example, related to the radio wave reflections which may occur. These different paths each involve different signal transmission conditions, such as for example the signal transmission time and signal transmission strength. In order to ultimately be able to sum the information received on these different paths, the receipt of this information needs to be time-adjusted. For this purpose, the time shifts between the different paths are determined by applying a path detection algorithm.

These differences can be determined on the basis of a predefined reference signal known in advance, which is sent on a common pilot channel referred to as CPICH. This reference signal is received on the different paths. The signal received on the CPICH channel is then correlated to the corresponding predefined reference signal. After correlation, a signal is obtained that has successive amplitude peaks spaced apart by the transmission delays on the different paths.

FIG. 3 illustrates an implementation of such a path detection. The reference signal is received on the CPICH channel 31 for processing by a matched filter. In this matched filter a signal correlation is applied between the signal received on the CPICH channel and the reference signal which is predefined. After this correlation, the correlated signal obtained indicates amplitude peaks 33 which correspond to the paths taken by the signal transmitted between the base station and the terminal. The time shifts between the different paths are then deduced.

Using these time lags, the different paths are synchronized so the information sent on the PICH channel can be received.

At the end of step C, one therefore has the time lags between the different paths taken from the base station to the terminal. Next, in step D, the PICH is detected (using a Rake receiver) to determine whether the value of the PI indicates that the terminal is to remain active or can return to its standby mode. This step D is carried out by a Rake receiver. The steps C and D must be done sequentially, which represents a loss of time.

In this step D, the different radio paths are respectively time-adjusted on the basis of the time lags calculated relative to the CPICH in the step C. Then, the received signals are added to obtain the value of the PI state information in a step E (PICH Rx). Here, the value of the PI either indicates that the terminal is to remain active, or that it can return to the standby state.

A terminal in standby mode must periodically execute steps A-E in order to determine the value of the PI.

The implementation of these steps consumes the terminal's power and therefore shortens its autonomy.

The present invention aims to improve the situation.

A first aspect of the invention proposes a method for receiving signal transmitted in a radio telecommunications network,

said method comprising the following steps, executed in a receiving unit:
/a/ receiving a radio signal carrying a common pilot channel and another channel, said other channel carrying state information;
/b/ obtaining, from the radio signal, a first signal by channel estimation on the common pilot channel, and a second signal by correlation of the radio signal with a reference code;
/c/ obtaining a resulting signal by complex conjugate multiplication of the first signal with the second signal; and
/d/ determining a value for the state information indicated in the second signal on the basis of the resulting signal.

In such a method, a signal is received in a receiving unit such as a chip or integrated circuit and/or microprocessor, housed in a receiver such as a mobile terminal, said signal carrying both a common pilot channel which can be a CPICH channel, and another channel which can be a PICH channel in a UMTS telecommunications network, in order to determine the future state of the active or sleeping terminal. After processing the received radio signal on the basis of transmission properties of the transmission signals used, a first signal and a second signal are obtained. The first signal corresponds to a signal carried by the common pilot channel and the second signal corresponds to a signal carried by the other channel which transports the state information. These first and second signals are multiplied in a complex conjugate manner in order to obtain a resulting signal from which it is easy to deduce the value of the state information. The first signal is obtained from the received radio signal by applying a channel estimation to the common pilot channel.

The term “channel estimation” is understood to mean the estimation of the parameters characterizing the transmission channel considered, such as for example propagation path delays, a magnitude for each of these paths, a phase shift between these paths, a level of additive white noise, etc. The first signal obtained in this manner therefore represents the characteristics of the common pilot channel.

The term “correlation” is understood to mean an operation consisting of multiplying and summing a signal with another signal. More specifically, a correlation is applied here between the received radio signal and a reference code for a physical channel located below the transport layer according to the OSI (Open Systems Interconnection) model. This reference code is transported here by an electronic signal which is correlated to the received radio signal.

This operation yields a second signal which indicates whether or not a reference signal, here the reference code, is present in the received radio signal. This signal correlation operation can advantageously be implemented in a matched filter. Such a matched filter allows optimizing a signal-to-noise ratio (SNR). The filter matching corresponds to applying, to the signal received, reference codes respectively assigned to the CPICH channel and to the PICH channel. More specifically, the filter is matched using the reference codes of the CPICH and PICH channels as filter coefficients. Then the received radio signal is injected into the matched filter. Thus a correlation between the received radio signal and the respective reference codes of the channels considered is applied by filtering.

No limitation is placed on the present invention concerning this signal correlation and channel estimation step.

In one embodiment of the invention, the channel estimation on the common pilot channel and the correlation of the received radio signal are done in parallel on the received radio signal.

Alternatively, the channel estimation on the common pilot channel and the correlation of the received radio signal can be done sequentially over time on the received radio signal. In this case, the size of the memory components can advantageously be limited, using a single signal multiplier.

Then, by multiplying these first and second signals in a complex conjugate manner, one is ultimately able to provide a resulting signal which can be used to determine the state information transported in the second signal transmitted on the PICH channel. It is then easy to place the mobile terminal in an active or standby state as a function of this state information. In a UMTS context, this state information corresponds to the Paging Indicator.

This complex conjugate multiplication step advantageously allows detecting the PI value carried on the PICH channel in a rapid and simple manner.

Through these correlation and multiplication operations, it is possible to determine the state value without performing a path detection step beforehand on the basis of a correlation applied to the signal sent on the CPICH channel. Here the first signal transported on the CPICH channel is used directly, multiplying it with the second signal obtained relative to the PICH channel.

By using such a method, it is advantageously possible to reduce the time spent determining the value of the state information indicated in the second signal. Thus, one can reduce the amount of power consumed by a mobile terminal which, in the standby state, is still constrained to receive state information such as PI information in order to know whether it can return to standby mode or must wake up to receive an incoming call or message.

In one embodiment of the invention, as the resulting signal has complex components, a value of the state information is determined on the basis of complex components. These components of the signal correspond to processing applied to a sampled received radio signal, with each sample of the signal corresponding to a component. All the complex components of the resulting signal can be taken into account in this manner, by summing for example first the real parts of these complex components, then the imaginary parts of these components, and then summing the sum of the real parts of the components with the sum of the imaginary parts of these components. Then, if the end result of the final sum is positive one can deduce that the value of the state information is positive, otherwise it is negative. If the final sum is positive one can consider the value of the state information to be equal to 0, and if the last sum is negative one can consider the value of the state information to be equal to 1.

A value of the state information can be also determined on the basis of complex components selected from among the complex components of the resulting signal. In this case, only the real and imaginary parts of the selected components are summed. Advantageously, this operation of determining the value of the state information can be reduced. For example, one can select the components of the resulting signal that have the largest values in the real part and/or the imaginary part. In this case, samples which do not correspond to the propagation paths can advantageously be excluded.

In one embodiment, a value of the state information is determined on the basis of the complex component real parts. This allows reducing the number of sums to be performed. It is then sufficient to sum the real parts only.

In all these different cases, the value of the state information can be easily determined on the basis of the sign of the result of the final sum calculated.

A second aspect of the invention proposes a microprocessor adapted to execute the steps of the method for receiving signals according to the first aspect of the invention.

A third aspect of the invention proposes a terminal comprising a receiving unit according to the second aspect of the invention.

A fourth aspect of the invention proposes a system comprising a base station adapted to emit a radio signal carrying a common pilot channel and another channel, said other channel carrying state information (PI), and a terminal according to the third aspect of the invention.

Other features, advantages, and aspects of the invention will be apparent from reading the following description of one of its embodiments.

The invention will also be better understood by referring to the attached drawings, in which:

FIG. 1 illustrates a mobile radio telecommunications network;

FIG. 2 illustrates a sequence of steps for determining a value of a Paging Indicator in a UMTS network according to the prior art;

FIG. 3 illustrates an implementation of such a path detection according to the prior art;

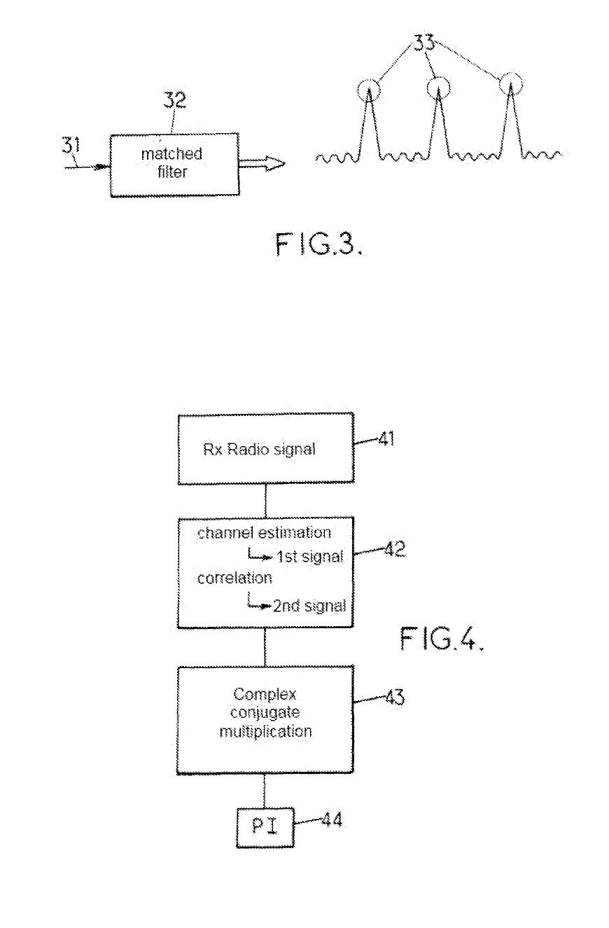

FIG. 4 illustrates the main steps of a method according to an embodiment of the invention;

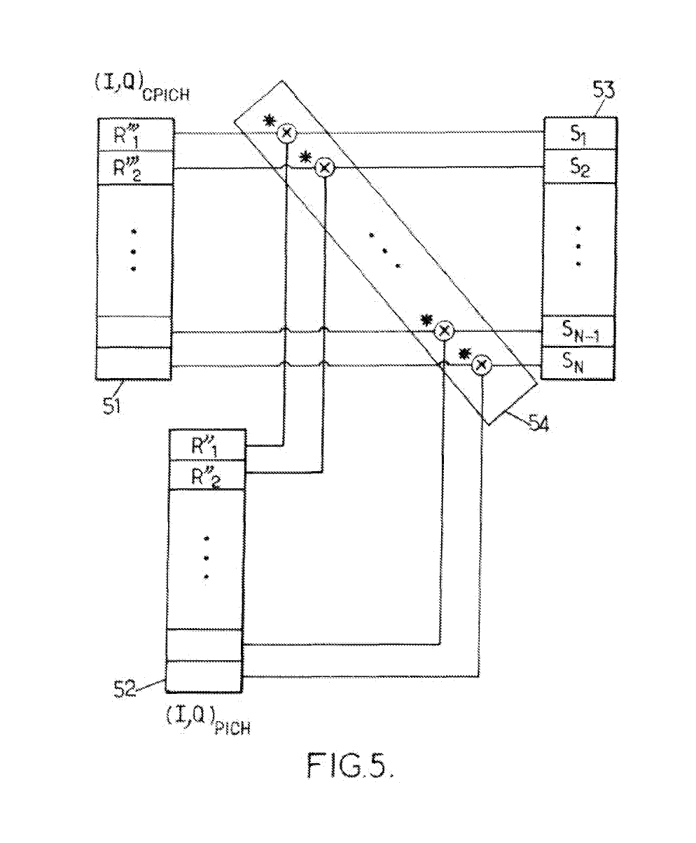

FIG. 5 illustrates the processing of a received signal, comprising a step of complex conjugate multiplication of the signals according to an embodiment of the invention;

FIG. 6 illustrates an embodiment adapted to implement a method for receiving signals according to an embodiment of the invention;

FIG. 7 schematically illustrates another embodiment of the invention; and

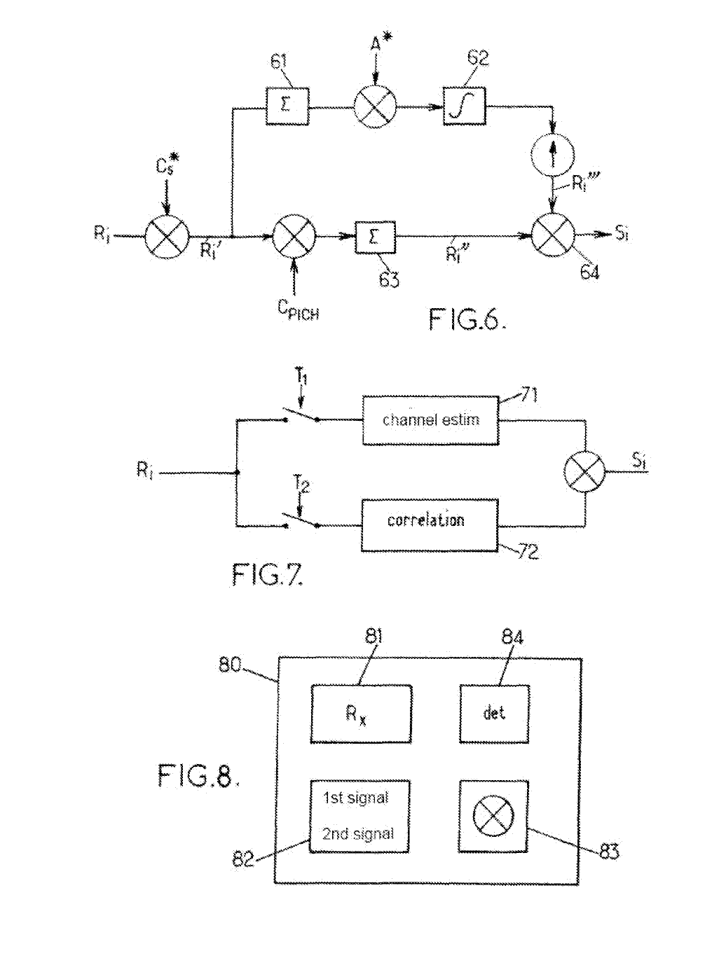

FIG. 8 illustrates a signal receiving unit according to an embodiment of the invention.

FIG. 4 illustrates the main steps of a method for receiving signals according to an embodiment of the invention.

The invention is described below as it applies to the UMTS network illustrated in FIG. 1. In this network, a mobile terminal is preferably maintained in a standby state when it is not required to be in an active state. A base station periodically sends state information, or PI (Paging Indicator) information, on a PICH channel. In addition, a predefined reference signal is sent on a CPICH common pilot channel.

At the terminal, a receiving unit, which can be an integrated circuit and/or a microprocessor, is adapted to implement the following steps. In a step 41, this receiving unit receives a radio signal which carries the common pilot channel and another transmission channel, the PICH channel. Next, in a step 42, a first signal is obtained by applying channel estimation to the common pilot channel. A second signal is obtained by correlation of the received radio signal to the reference code for the PICH channel. This step can advantageously be performed using a matched filter. This step 42 corresponds, in one embodiment of the invention, to applying two matched filters to the signal received at the terminal.

More specifically, the received signal comprises an in-phase component I and a quadrature-phase component Q. Thus, at the end of the respective steps of channel estimation for the CPICH channel and correlation for the PICH channel, first and second signals are obtained which are respectively represented by first and second components I and Q.

Then, in a step 43, a resulting signal is obtained by complex conjugate multiplication of the first and second components of the first signal with the first and second components of the second signal.

Then a value for the state information indicated in the second signal is determined on the basis of this resulting signal, in a step 44.

This complex multiplication allows advantageously replacing the prior step of determining paths for the first signal of the common pilot channel, as well as the one consisting of taking into account the time lags between the different paths in order to determine a value for the PI state information. Referring to FIG. 2, it is possible to reduce the period of time required for the steps A-E, by eliminating at least the periods of time corresponding to the step C and the period of time separating the step C and the step D. It is thus possible to reduce the time required for this detection of the PI and therefore to reduce the power used by the terminal for processing the receiving of the PI. As a result, the power autonomy of a mobile terminal in a UMTS network can be increased.

FIG. 5 illustrates a processing of a received signal which comprises a complex conjugate multiplication step according to an embodiment of the invention.

In the receiving unit, a signal is received to which are applied a correlation relative to the signal carried by the PICH channel, and a channel estimation relative to the CPICH channel. The channel estimation relative to the CPICH channel is based on the code used on this transmission channel and on the predefined reference signal which is sent on this channel. The correlation relative to the signal carried by the PICH channel is also based on the code used on this transmission channel. These channel estimation and correlation steps are applied to signal samples which are each expressed as two components I and Q. The received radio signal is sampled for this purpose.

A first signal 51 and a second signal 52 result from these steps. Each of these first and second signals can be written in vector form with the respective components R″ and R″′ written in complex form, the real part corresponding to the I component of the signal sample and the imaginary part corresponding to the Q component of the signal sample.

A complex conjugate multiplication is then applied between these two vectors 51 and 52, which is illustrated by the block 54. A resulting signal 53 is obtained. This resulting signal 53 can also be written as a vector of components Sᵢ.

From this resulting signal 53 it is then easy to determine a value for the state information sent in the PICH channel. It is sufficient to sum the components of the resulting signal 53 to determine this value. This state information (or paging indicator value) can assume two values, a value indicating an active state, or “paged” state, and another value indicating a standby state.

In one embodiment of the invention, a sum value is obtained by summing all or part of the components of the vector representing the resulting signal 53. For example, this sum value is either greater than zero and in this case one accordingly deduces that the value of the Paging Indicator state information is equal to zero, or it is less than zero and one then deduces that the value of the Paging Indicator state information is equal to 1. No limitation is placed on the present invention regarding the determination of the value of the state information from the sum of all or part of the components of the resulting signal.

No limitation is placed on the type of sum that is applied here. In one embodiment of the invention, all components of the resulting signal 53 are summed. In this case, the real parts and the imaginary parts of all components are summed together to obtain a sum value that allows determining the PI state information.

In another embodiment, only the real components of this resulting signal 53 are summed. This embodiment advantageously simplifies the electronic architecture and the processing to be applied to the signal.

One can also select only certain complex components using an appropriate criterion. Such a criterion can take into account the magnitude of these components. The sum is then calculated from the selected components, either from only the real parts of the selected components, or from both the real and imaginary parts of these selected components.

Such an embodiment advantageously allows rapidly and easily determining a Paging Indicator value by directly manipulating the samples of the first and second signals as described above. This method eliminates a prior step of determining paths on the basis of the signal received on the CPICH common pilot channel. In addition, the step of summing the samples corresponding to the resulting signal 53 is easy to implement and allows efficient determination of a PI value in order to manage the terminal state change where necessary.

FIG. 6 illustrates an embodiment adapted to implement the receiving of a signal at a receiving unit according to an embodiment of the invention. In this embodiment, the received radio signal carrying the CPICH channel and the PICH channel is processed simultaneously, in parallel, using a channel estimation relative to the CPICH channel and a signal correlation relative to the PICH channel.

In this embodiment, the resulting signal 53 provided in the step 43 of the method for receiving signals is obtained from the signal received at the receiving unit, in an efficient and simple manner.

In this context, a scrambling code Cₛ is used in the network considered, as well as a code C_{CPICH} for transmissions made on the CPICH common pilot channel and a code C_{PICH} for transmissions made on the PICH channel.

The signal received is sampled, with the samples denoted as Rᵢ where i is between 1 and N, N being a whole number. N can be determined as a function of a characteristic of the radio propagation channel, such as pulse broadening. N can for example be equal to 80, which is a value in compliance with the UMTS 3GPP standard. In this context, a sample Rᵢ of the received signal can satisfy the following equation:

Rᵢ=W_{i×C}ₛ×(C_{CPICH}×A+C_{PICH}×S_{PICH})+n
where A is a symbol continuously emitted on the CPICH common pilot channel;
where S_{PICH} is the signal emitted on the PICH channel;
where Wᵢ is a radio propagation factor relative to the sample Rᵢ;
where n is a noise level affecting the transmission considered.

The sample Ri of the received signal is first multiplied by the conjugate of the scrambling code Cₛ used in the network in question in order to “unscramble” the signal received and obtain an “unscrambled” sample Rᵢ′. Then this sample Rᵢ′ is processed in a first path (bottom path) relative to the PICH channel and in a second path (top path) relative to the CPICH channel. The first processing path correlates the signal sent on the PICH channel and the second processing path applies a channel estimation to the CPICH channel.

One should note that no limitation is placed on the implementation of the signal correlation relative to the PICH channel nor on the implementation of the channel estimation relative to the CPICH channel.

For example, in one embodiment, in the first processing path, the sample Rᵢ′ is multiplied by the code C_{PICH} before being integrated over an interval corresponding to the size of the spreading factor of the PICH channel, SF_{DPCH}, at an integrator 63. The integrator 63 outputs a sample Rᵢ″:

$${R}_{i}^{″} = {\sum }_{256} {R}_{i} \times {C}_{PICH} = 256 \times C \times {S}_{PICH} + {n}^{′}$$

In the second processing path, the sample Rᵢ′ is integrated, by an integrator 61, over the interval of the CPICH spreading factor SF_{CPICH}, before being multiplied by the conjugate of the symbol emitted on the CPICH channel denoted A. The output from this multiplication is:

$${R}_{i}^{′′′} = {\sum }_{256} {R}_{i} \times {C}_{CPICH} \times {A}^{*} = 256 \times \vert A \vert \times C + {n}^{″}$$

where n″ is a signal noise level.

Next, a filter 62 is applied to this signal in order to average the result. No limitation is placed on the integration interval of the filter. Then, in a multiplier 64, the signal issuing from the processing applied by the first processing path and the signal issuing from the processing applied by the second processing path are multiplied in a complex conjugate manner. The output from the multiplier 64 is a component Sᵢ of the resulting signal 53 corresponding to the sample Rᵢ of the received signal:

Sᵢ=2¹⁶ (C×S_{PICH}+nᵢ)×(C*+nᵢ)=2¹⁶×|C|²×S_{PICH}+b
where b is a noise level resulting from the processing described above.

By applying the processing described above to all samples of the received signal Rᵢ, one ultimately obtains a resulting signal 53 in the form of a vector whose components are Sᵢ, satisfying the above equation.

Then all or part of these components are summed and a value for the PI state information can easily be obtained.

FIG. 7 schematically illustrates another embodiment, adapted to implement the receiving of a signal at a receiving unit according to an embodiment of the invention, during which the channel estimation and the signal correlation are done sequentially over time on the received radio signal. In this case, the sample multiplier can advantageously be reused to do the signal correlation and the channel estimation in step b.

Here, the received radio signal can be processed, either by the top path consisting of applying a channel estimation 71 as described with reference to FIG. 6 for example, or by the bottom path consisting of applying a signal correlation 72 relative to the PICH channel. Thus, at a time T₁, the received radio signal is processed by the top path 71, and at a time T₂, it is processed by the bottom path 72. The times T₁ and T₂ are distinct from each other and thus allow sequentially applying the channel estimation and the correlation. One can provide for T₁ being less than T₂ or vice versa.

FIG. 8 illustrates a part of the architecture of a chip according to an embodiment of the invention.

Such a receiving unit 80 can comprise:
a receiving unit 81 adapted to receive a radio signal carrying a common pilot channel and another channel, said other channel carrying state information;
a first obtaining unit 82 adapted to obtain, from the radio signal, a first signal by channel estimation on the common pilot channel and a second signal by correlation of the received radio signal with a reference code;
a second obtaining unit 83 adapted to obtain a resulting signal by complex conjugate multiplication of the first signal with the second signal; and
a determination unit 84 adapted to determine a value for the state information indicated in the second signal on the basis of the resulting signal.

One should note that in this embodiment, some of these units can correspond to an integrated circuit and the other unit or units can correspond to a microprocessor.

Thus the determination unit 84 can correspond to a microprocessor and the other units can correspond to an integrated circuit.

1. A method for receiving signal transmitted in a radio telecommunications network, said method comprising the following steps executed in a receiving unit:
receiving a radio signal carrying a common pilot channel (CPICH) and another channel (PICH), said common pilot channel carrying out a predefined reference signal and said other channel carrying state information;
obtaining, from the radio signal, a first signal by channel estimation on the common pilot channel as a function of a code used on said common pilot channel and predefined reference signal transmitted on said common pilot channel; and a second signal by correlation of the received radio signal with a reference code;
obtaining a resulting signal by complex conjugate multiplication of the first signal with the second signal; and
determining a value for the state information indicated in the second signal on the basis of the resulting signal.

2. The method for receiving signal according to claim 1, wherein the channel estimation on the common pilot channel and the correlation of the received radio signal are done in parallel on the received radio signal.

3. The method for receiving signal according to claim 1, wherein the channel estimation on the common pilot channel and the correlation of the received radio signal are done sequentially over time on the received radio signal.

4. The method for receiving signal according to claim 1, wherein, as the resulting signal has complex components respectively corresponding to samples of the received signal, a value for the state information is determined on the basis of a sum of said complex components.

5. The method for receiving signal according to claim 4, wherein a value for the state information is determined on the basis of a sum of complex components selected from among the complex components of the resulting signal.

6. The method for receiving signals according to claim 4, wherein a value for the state information is determined on the basis of a sum of the real parts of complex components.

7. A signal receiving unit comprising a means for executing the steps of the method for receiving signal according to claim 1.

8. The signal receiving unit according to claim 7, comprising:
a receiving unit adapted to receive a radio signal carrying a common pilot channel (CPICH), said common pilot channel carrying out a predefined reference signal and another channel (PICH), said other channel carrying state information (PI);
a first obtaining unit adapted to obtain, from the radio signal, a first signal by channel estimation on the common pilot channel as a function of a code used on said common pilot channel and predefined reference signal transmitted on said common pilot channel; and a second signal by correlation of the received radio signal with a reference code;
a second obtaining unit adapted to obtain a resulting signal by complex conjugate multiplication of the first signal with the second signal; and
a determination unit adapted to determine a value for the state information indicated in the second signal on the basis of the resulting signal.

9. The signal receiving unit according to claim 8, wherein some of the units correspond to an integrated circuit and the other unit or units correspond to a microprocessor.

10. A terminal comprising a signal receiving unit according to claim 9.

11. A system comprising at least one base station adapted to emit a radio signal carrying a common pilot channel (CPICH) and another channel (PICH), said other channel carrying state information (PI), and a terminal according to claim 10.
